(19) United States
(12) Patent Application Publication
(10) Pub. No.: US 2013/0337195 A1
(43) Pub. Date: Dec. 19, 2013

(54) METHOD OF GROWING GRAPHENE NANOCRYSTALLINE LAYERS

(71) Applicant: The Trustees of Columbia University in the City of New York, (US)

(72) Inventors: Ulrich Wurstbauer, New York, NY (US); Jorge Manuel Garcia Martinez, Summit, NJ (US); Aron Pinczuk, Westfield, NJ (US)

(73) Assignee: The Trustees of Columbia University in the City of New York, New York, NY (US)

(21) Appl. No.: 13/801,438

(22) Filed: Mar. 13, 2013

Related U.S. Application Data
(63) Continuation of application No. PCT/US2012/042868, filed on Jun. 18, 2012.

(51) Int. Cl. C01B 31/04

(52) U.S. Cl. CPC C01B 31/0446
USPC 427/585; 118/726

(57) ABSTRACT

Systems and methods for applying a graphene nanocrystalline layer on a substrate in a vacuum chamber including positioning the substrate in the vacuum chamber, evacuating the vacuum chamber to a pressure of less than 10⁻³ torr, and applying an electrical current to the glassy carbon filament to generate graphene carbon, in which the substrate is positioned in a location to receive at least a portion of the graphene carbon upon the application of current.

### PRIORITY CLAIM

This application is a continuation of International Application No. PCT/US2012/042868, filed Jun. 18, 2012, which claims the benefit of U.S. Provisional Patent Application No. 61/503,370 filed Jun. 30, 2011, which is hereby incorporated by reference in its entirety.

### GRANT INFORMATION

This invention was made with government support under U.S. Office of Naval Research Grant No. N00014-06-10138 awarded by the U.S. Office of Naval Research, Grant No. UMARY Z894102 awarded by the U.S. Office of Naval Research—Multi-University Research Initiative, and Grant No. CHE-06-41523 awarded by the U.S. National Science Foundation NSEC Initiative. The U.S. government has certain rights in the invention.

This invention was also made with the support of the Spanish National Research Council (CSIC) under Spanish grants: MEC (ENE2009-14481-002-02, TEC201′-29120-005-04, MAT2011-26534, Consolider QOIT (CSD2006-0019), Consolider GENESIS MEC (CSD2006-0004) and Salvador de Madariaga Grant No. PR20070036. The Spanish government has certain rights in the invention.

### BACKGROUND

The presently disclosed subject matter relates to techniques for growing graphene nanocrystalline layers.

Graphene can be produced by several methods. One method involves using an adhesive material to peel micron-size graphene layers off of a thick crystal whose lattice structure is that of graphene. Large area graphene, i.e., 0.1 to 10 millimeters by 0.1 to 10 millimeters can also be produced by selectively evaporating silicon off of a surface of silicon carbide at high temperatures.

Another method to produce large area graphene layers uses molecular beam epitaxy (MBE) in which effusion cells loaded with source materials in solid or liquid form are heated to vaporize the material and generate beams of atoms or molecules within a vacuum that can be directed at the single crystal substrate or wafer. This method can be limited to growing epitaxial layers, which require that the substrate must have a crystalline orientation and only produces graphene layer in the same crystalline orientation as the substrate.

Chemical vapor deposition (CVD), in which a transition metal layer is used to synthesize layers of graphene on the metal, can also be used to grow graphene sheets on transition metals, which can be transferred onto the substrate of interest. Examples of such substrates include oxides, nitrides and other insulators.

### SUMMARY

The disclosed subject matter also provides systems for deposition of a graphene nanocrystalline layer on a substrate using one or more glassy carbon filaments. In one embodiment, the system includes a vacuum chamber adapted to provide a pressure of less than about 10⁻³ torr and one or more sets of electrical contacts, each coupled to the vacuum chamber and configured to receive at least one of the one or more glassy carbon filaments, to provide a source of carbon for graphene growth upon application of a current to the filaments.

The system also includes a heating element, coupled to the vacuum chamber and adapted to heat the one or more glassy carbon filaments to a temperature that results in evaporation of the glassy carbon filament when the pressure is of less than about 10⁻³ torr. The system can include at least one substrate holder, adapted to receive the substrate, and disposed in the vacuum chamber in a location to receive at least a portion of the graphene carbon upon the application of the current to the one or more glassy carbon filaments when heated to a temperature that results in evaporation of the glassy carbon filament when the pressure is of less than about 10⁻³ torr. The system can also include a shutter coupled to the vacuum chamber to mechanically control the amount of carbon delivered to the substrate.

The heating element can be adapted to heat the one or more glassy carbon filaments to a temperature of at least 1,900° C. The vacuum chamber can be adapted to provide a pressure of less than about 10⁻⁶ torr. The graphene nanocrystalline layer can be sub-monolayer thin. In one embodiment, the graphene nanocrystalline layer can be a large scale graphene layer.

The disclosed subject matter also provides techniques for growing nanocrystalline graphene layers directly on a substrate, when the substrate can be any material, device, or apparatus that is able to withstand the pressure and temperature generated in the system. One embodiment includes positioning the substrate in the vacuum chamber, evacuating the vacuum chamber to a pressure of less than 10⁻³ torr, and applying an electrical current to the glassy carbon filament to generate a beam of carbon. The substrate can be positioned to dispose the substrate in a location to receive at least a portion of carbon upon the application of current. In one embodiment, the amount of carbon delivered to the substrate is mechanically controlled.

In certain embodiments, the glassy carbon filament can be heated to a temperature that results in evaporation of the glassy carbon filament. In some embodiments, the glassy carbon filament is heated to a temperature of at least 1,900° C. In one embodiment, the method further provides a pressure of less than about 10⁻⁶ torr. In certain embodiments, the method further utilizes a high or ultra high vacuum.

In some embodiments, the method further includes providing a substrate in proximity to the sample, such as a dielectric substrate or a semiconducting substrate.

In certain embodiments, the current applied is at least 7.5 A.

### BRIEF DESCRIPTION OF THE FIGURES

FIG. 1 shows an exemplary embodiment of a system for growing graphene nanocrystalline layers on a substrate in accordance with the disclosed subject matter.

FIG. 2 is a diagram illustrating an exemplar operation of the system shown in

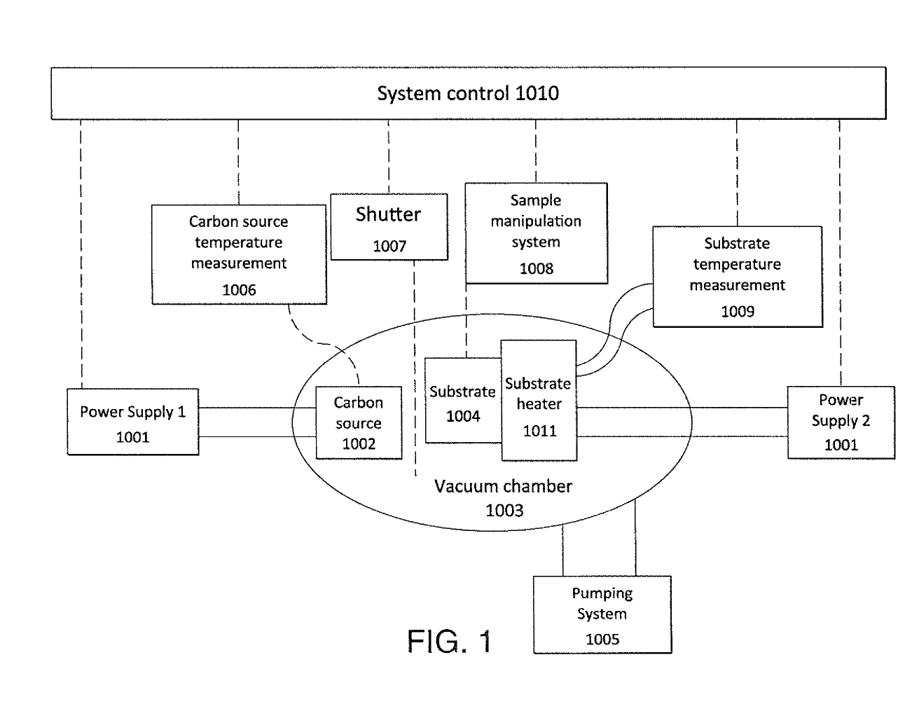

FIG. 1.

FIG. 3 shows one embodiment of the glassy carbon filament of FIG. 1.

FIG. 4 shows one example of the positioning of the substrate relative to the glassy carbon filament.

FIG. 5 shows the Near Edge X-ray Absorption Fine Structure spectrum of the graphene layer on mica produced in Example 1 and the Near Edge X-ray Absorption Fine Structure spectrum of graphene produced by chemical vapor deposition.

FIG. 6 shows the Micron-Raman spectrum of the graphene layer on mica produced in Example 1.

FIG. 7 shows the scanning tunneling spectrum of the graphene layer on mica produced in Example 1.

FIG. 8 shows the atomic force microscopy measurement of the film thickness versus the length of the mica for the graphene layer on mica produced in Example 1.

FIG. 9 shows the Micron-Raman spectrum of the graphene layer on silicon dioxide produced in Example 2.

FIG. 10(a) shows a schematic diagram of an alternate embodiment of a system for growing graphene nanocrystalline layers on a substrate. FIG. 10(b) shows a photograph of an ultra-thin graphene film on a SiO₂ substrate produced in Example 3. FIG. 10(c) shows a schematic of graphene film growth.

FIG. 11(a) shows a schematic separating the high growth rates and low-growth rates areas on a substrate. FIGS. 11(b) and 11(c) show typical Raman and NEXAFS measurements for a MBG film grown on a 300 nm-thick SiO₂ layer on Si in Example 3.

FIG. 12 shows the NEXAFS spectra for the SiO₂, mica, and CVD graphene films produced in Example 4.

FIGS. 13(a)-(e) show the Micro Raman spectra on MBG graphene nanocrystals on amorphous SiO₂ measured at various growth rates in Example 3. FIG. 13(f) shows the crystal grain size estimated from the ratio of the D and G modes in Example 3.

FIG. 14 shows the orientation-independent Near Edge X-ray Absorption Fine Structure spectra of a thick graphene film, a film prepared from glassy carbon, and a film prepared from highly-ordered pyrolytic graphite produced in Example 5.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The disclosed subject matter provides techniques for growing nanocrystalline graphene layers on a substrate using vacuum evaporation of carbon at relatively low temperatures, and can be referred to as “molecular beam growth” or MBG. Large scale graphene nanoerystal films can be grown directly on substrate rates without requiring that films be formed onto certain metals and then transferred onto a different substrate, and without necessarily resulting in epitaxial growth. The substrate can be any material, device, or apparatus that is able to withstand the pressure and temperature generated in the system. The amount of carbon can be accurately controlled both with the temperature of the carbon filament and the duration time of deposition.

Graphene typically refers to a single planar sheet of covalently bonded carbon atoms and is believed to be formed of a plane of carbon atoms that are sp²-bonded carbon to form a regular hexagonal lattice with an aromatic structure.

In one embodiment, the disclosed subject matter produces graphene films that are transparent or semitransparent and conductive. The method can produce large scale graphene layers that are close to one monolayer thin, i.e. that are close to approximately 3.35 Å thin. In certain embodiments, the combination of highly controllable growth conditions and dielectric substrates produces films that do not require exfoliation for further examples, and facilitates comprehensive in-depth characterization.

FIG. 1 is a block diagram of a system in accordance with an exemplary embodiment of the disclosed subject matter. FIG. 1 shows a vacuum chamber 1003 that contains two power supplies 1001 adapted to provide power to the carbon source 1002 and substrate 1004; a carbon source 1002 in electrical communication with the electrical contacts 1001 and disposed in the vacuum chamber 1003 to provide a source of carbon for graphene growth. The vacuum chamber 1003 is connected to a pumping system 1005 for providing vacuum suction.

The system can optionally include additional components that are depicted in FIG. 1. The system can include a carbon source temperature measurement 1006 and substrate temperature measurement 1009 for measuring the temperature of the carbon source and substrate, respectively. Other optional components include a shutter 1007 to mechanically control the amount of carbon delivered to the substrate and a sample manipulation system 1008 for moving and otherwise manipulating the substrate. The system can further include a system control 1010 for controlling and directing the system. The system can also include a substrate heater 1011.

In certain embodiments, the substrate 1004 is disposed in the vacuum chamber 1003 in a location to receive at least a portion of the graphene carbon upon the application of current to the carbon source 1002. In one embodiment, the power supplies 1001 include electrical contacts adapted to receive current.

As used herein, the term “High Vacuum” or “HV” refers to a vacuum at a pressure of about 10⁻⁶ to about 10⁻⁸ torr.

As used herein, the term “Ultra High Vacuum” or “UHV” refers to a vacuum at a pressure of about 10⁻⁹ torr.

As used herein, the term “deep Ultra High Vacuum” or “deep UHV” refers to a vacuum at a pressure of less than about 10⁻⁹ torr.

As used herein, the term “nanocrystalline layer” refers to a layer that has at least one dimension that is equal to or smaller than 100 nm and that is single crystalline.

The power supply 1001 can be an electrical contact made from any refractory material. Non-limiting examples of conductive refractory materials include tantalum, molybdenum, and tungsten. Alternatively, the materials for electrical contact 1001 can include discrete sections of two or more conducting materials. The electrical contact materials can be made from any conductive material, provided that the material in direct electrical communication with the glassy carbon filament is made of a refractory material. Non-limiting examples of electrical conductive materials include tantalum, molybdenum, tungsten, lithium, palladium, platinum, silver, copper, gold, aluminum, zinc, nickel, brass, bronze, iron, platinum, steel, and alloys thereof.

The carbon source 1002 can be a glassy carbon filament having any shape. There is no limitation on the size of the glassy carbon filament 1002, except that larger filaments will require larger currents. In certain embodiments, the glassy carbon filament 1002 is laser-cut into a particular shape. In certain embodiments, the glassy carbon filament 1002 is in the shape of a plate. The glassy carbon material for the glassy carbon filament 1002 can be purchased in the shape of plates directly from a supplier, such as HTW Hochtemperature-Werkstoffe GmbH (Thierhaupten, Germany). In specific embodiments, the glassy carbon filament 1002 is “dog-bone” shaped. In certain embodiments, the ring-shaped ends of the glassy carbon filament 1002 are connected by an integrally-formed metal strip. In one embodiment, one or more concavities are formed where the ring-shaped end connects with the thin strip. In certain embodiments, the electrical contacts 1001 can be inserted through the one or more concavities in the ring-shaped end of the glassy carbon filament 1002. In certain embodiments, the glassy carbon filament 1002 is adapted to engage with at least two electrical contacts 1001 at or near two ends of the glassy carbon filament 1002. In one embodiment, the glassy carbon filament 1002 is provided with apertures and engaged with the at least two electrical contacts via a metal screw and a washer.

The glassy carbon filament 1002 can have any dimensions that allow the system to function properly. In some embodiments, the glassy carbon filament 1002 has a thickness of from about 5 μm to about 1 cm. In certain embodiments, the glassy carbon filament 1002 has a thickness of from about 5 μm to about 50 μm. In certain embodiments, the glassy carbon filament 1002 has a thickness of from about 50 μm to about 300 μm, about 300 μm to about 500 μm, about 500 μm to about 1,500 μm, about 1.5 mm to about 5 mm, about 5 mm to about 1 cm, or about 5 mm to about 20 mm.

The glassy carbon filament 1002 can be attached to the container as described in detail by Pfeiffer et al. in U.S. Pat. No. 7,329,595 (incorporated herein by reference) with a metal screw and a washer. In certain embodiments, the glassy carbon filament 1002 is adapted to engage with at least two electrical contacts 1001 at or near two ends of the glassy carbon filament 1002. In one embodiment, the glassy carbon filament 1002 is provided with apertures and engaged with at least two electrical contacts 1001 via one or connectors. The connectors can be made of any low vapor, highly temperature stable conducting material.

In another embodiment, two glassy carbon filaments 1002 can be used. In one embodiment, the two glassy carbon filaments 1002 can be disposed about opposing ends of the electrical contacts 1001, and the electrical contacts can be aligned perpendicular to the length of the filaments. In a certain embodiment, the basket can be disposed between the filaments 1002 and secured at opposing ends proximate to the thin metal strips of the filaments.

The vacuum chamber 1003 is an enclosed space that can be made of any material that is able to withstand the pressure and temperature generated in the system. The vacuum chamber 1003 can include a vacuum pump. Non-limiting examples of vacuum pumps include turbo-molecular pumps, cryogenic pumps, and ion pumps.

Vacuum conditions provide for the proper operation of the carbon source and the achievement of clean evaporation of carbon onto the substrate. In certain embodiments, the method provides a pressure range of from about 10⁻³ to about 10⁻⁹ torr. In some embodiments, the vacuum source provides a pressure range of from about 10⁻⁶ to about 10⁻⁹ torr. In certain embodiments, method provides a pressure range of from about 10⁻³ to about 10⁻⁶ torr. In certain embodiments, the method provides a pressure that is below about 10⁻⁹ torr.

In one embodiment, the system contains an inert gas and the pressure in the system is between about 800 torr and about 10⁻³ torr. Non-limiting examples of inert gases include nitrogen, helium, neon, argon, krypton, xenon, radon, sulfur hexafluoride, and mixtures thereof.

The substrate 1004 receiving the source of beam of carbon upon the application of current to the carbon source 1002 can be any material, device, or apparatus that is able to withstand the pressure and temperature generated in the system. The presently disclosed subject matter is not limited to crystalline substrates and can be applied to form graphene layers directly on glassy and amorphous substrates.

In certain embodiments, the substrate 1004 is a dielectric substrate. Non-limiting examples of dielectric substrates include glass, sapphire, mica, silicon dioxide, silicon nitride, silicon oxy-nitride, aluminum oxide, silicon carbide nitride, organo-silicate glass (OSG), carbon-doped silicon oxides (SiCO or CDO), methylsilsesquioxane (MSQ), and porous OSG (p-OSG).

In one embodiment, the substrate 1004 is a semiconducting substrate. Non-limiting examples of semiconducting substrates include silicon, such as silicon carbide, zinc selenide, gallium arsenide, gallium nitride, cadmium telluride and mercury cadmium telluride. In other embodiments, the substrate 1004 may include quartz, amorphous silicon dioxide, aluminum oxide, lithium niobate or other insulating material. The substrate 1004 may include layers of dielectric material or conductive material over the semiconductor material.

In certain embodiments, the substrate 1004 is positioned perpendicular to the glassy carbon filament 1002 at a distance that allows a controlled carbon gradient to be formed upon the substrate 1004 in order to provide a graphene layer thickness gradient. An example of a substrate 1004 positioned for growing a controlled carbon gradient is given in FIG. 4. The thickness variation of the resulting graphene layers can be measured by the following function:

Θ(d)=Θ₀/1+(d/D₀)²)² (1)

where Θ is the thickness, Θ/Θ₀ is the thickness variation, D₀ is the distance between the carbon source 1002, and d is the distance of normal incidence.

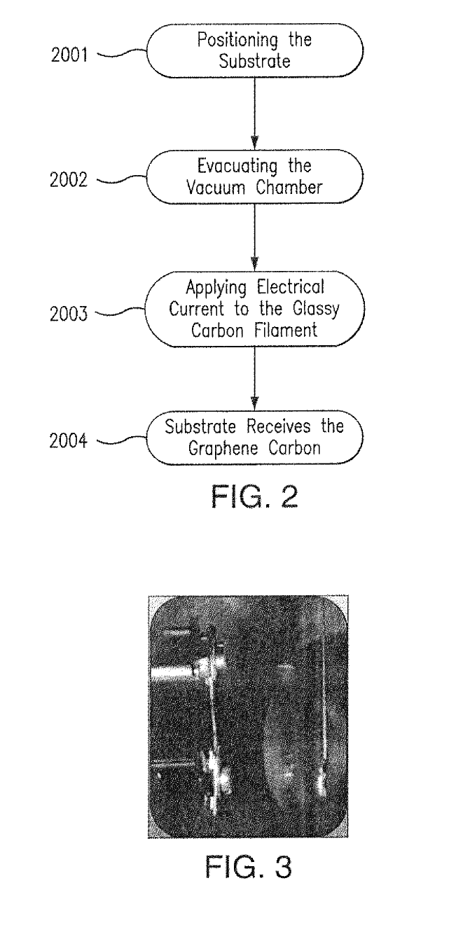

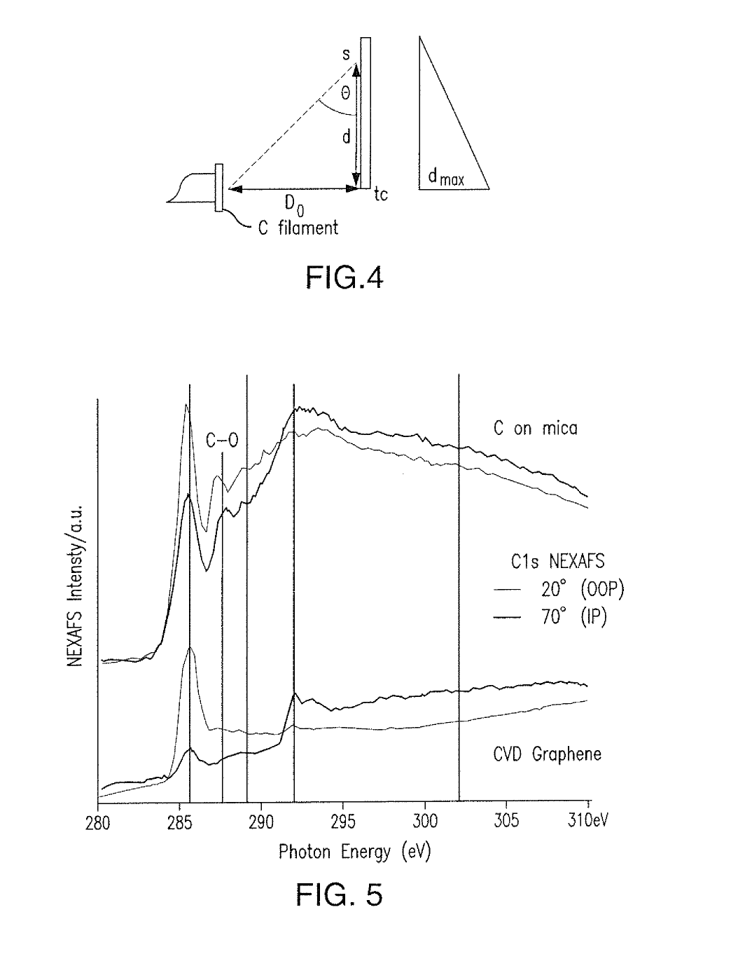

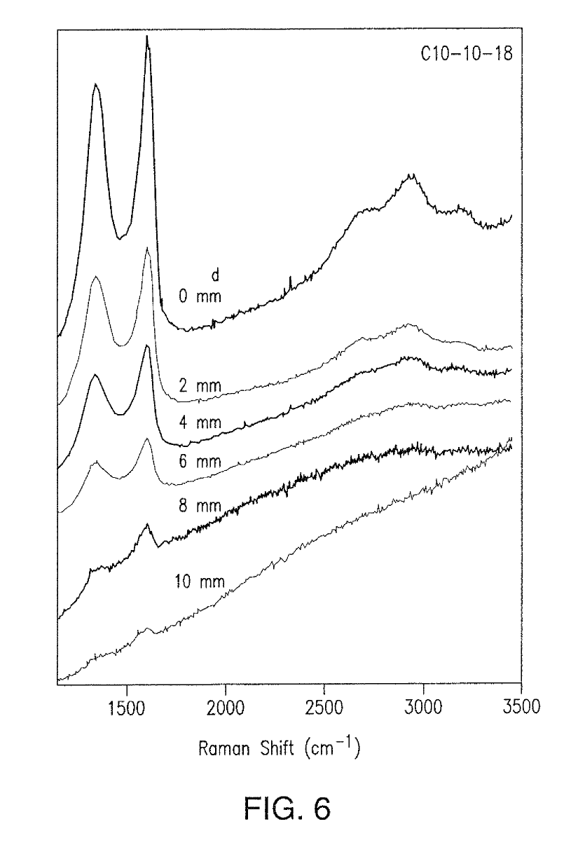

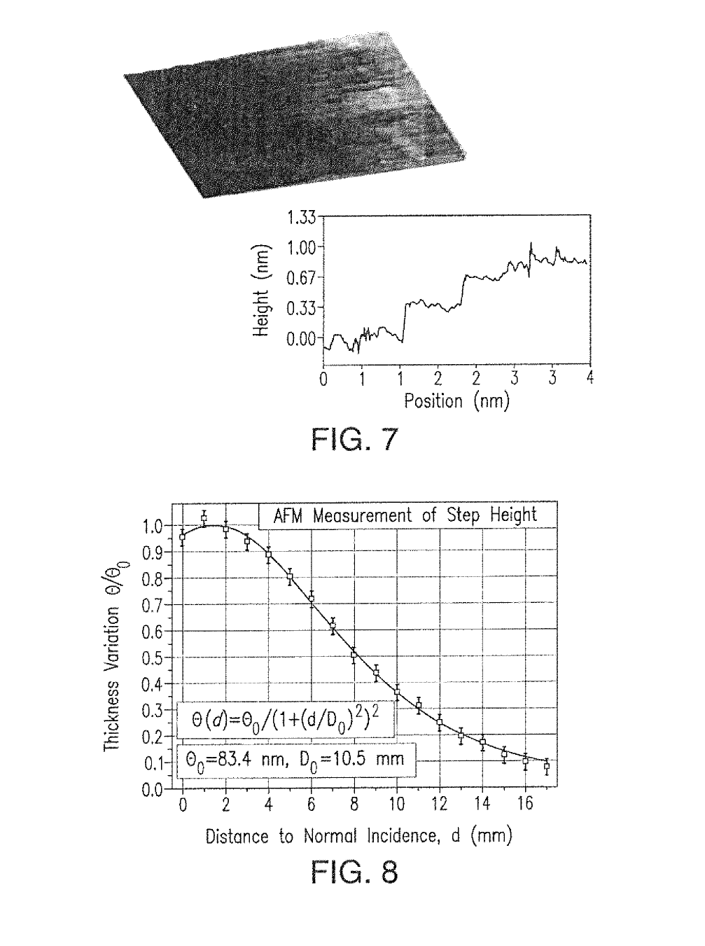

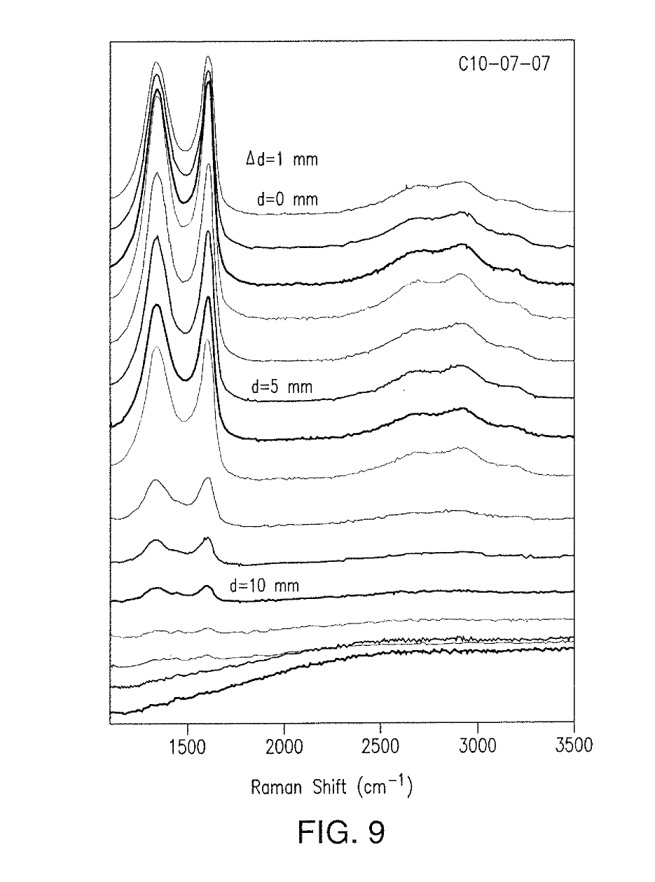

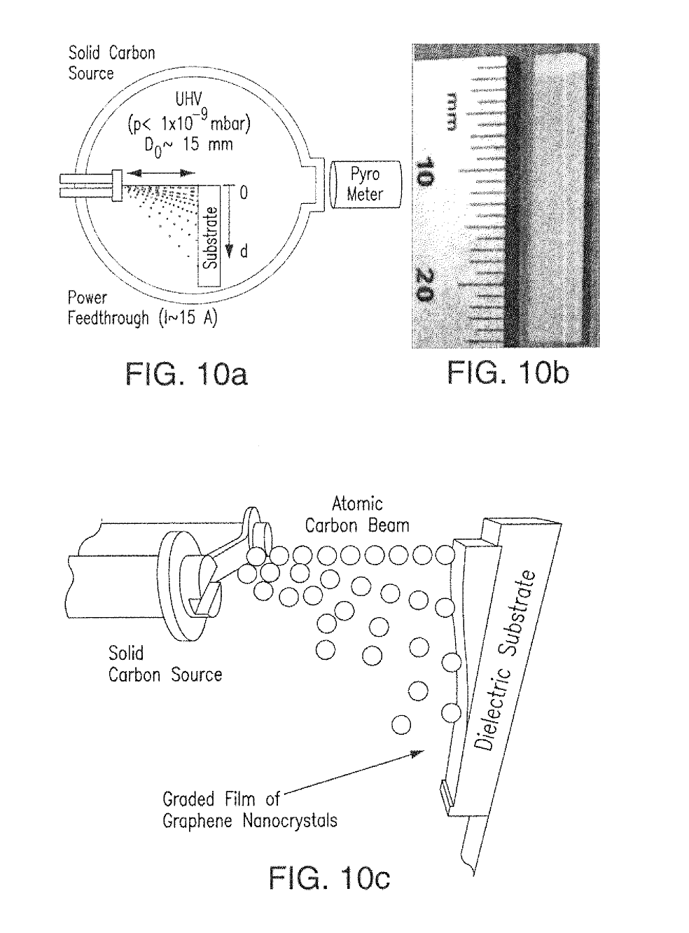

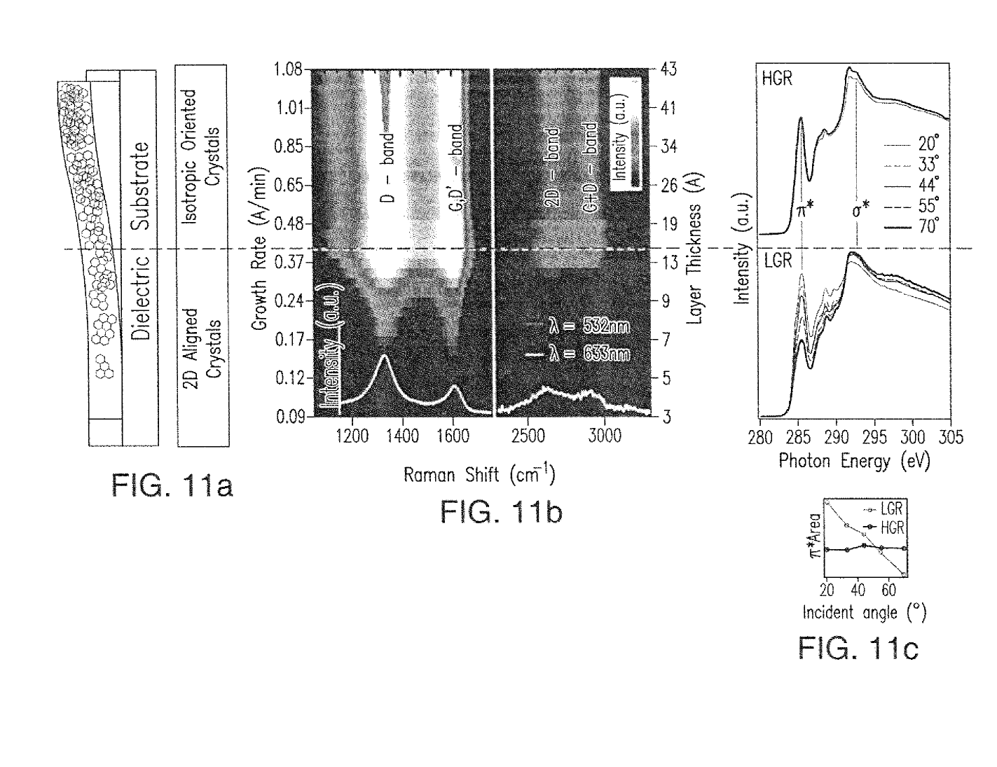

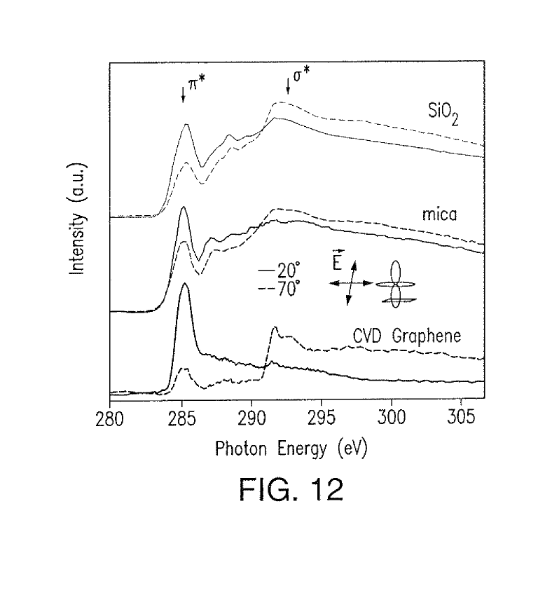

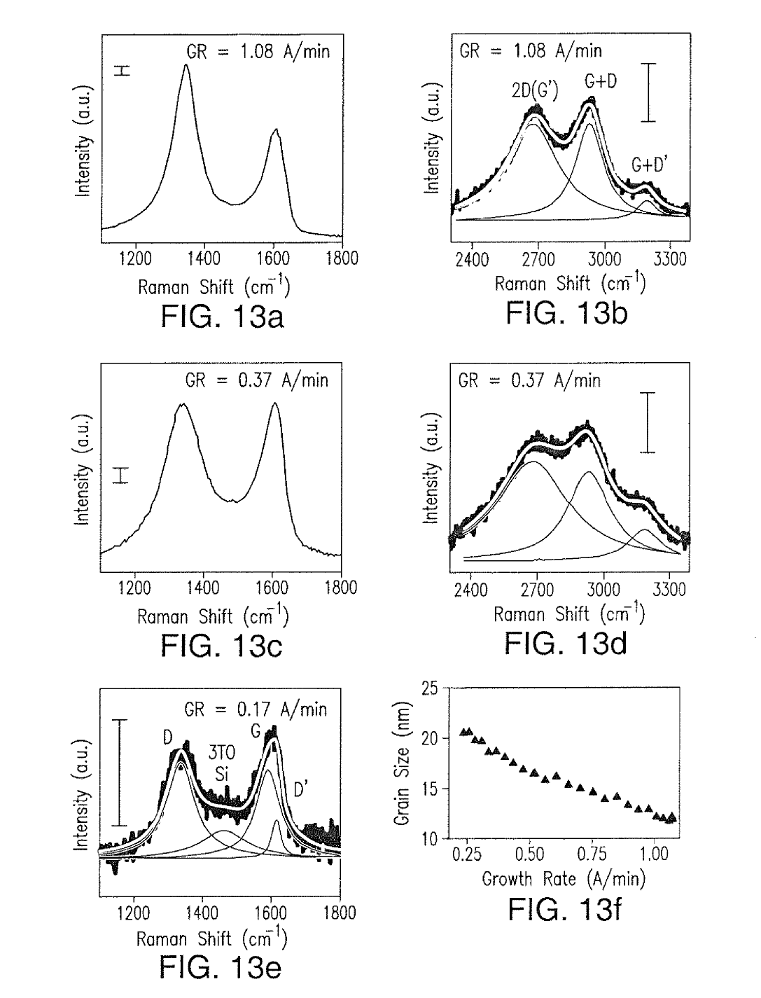

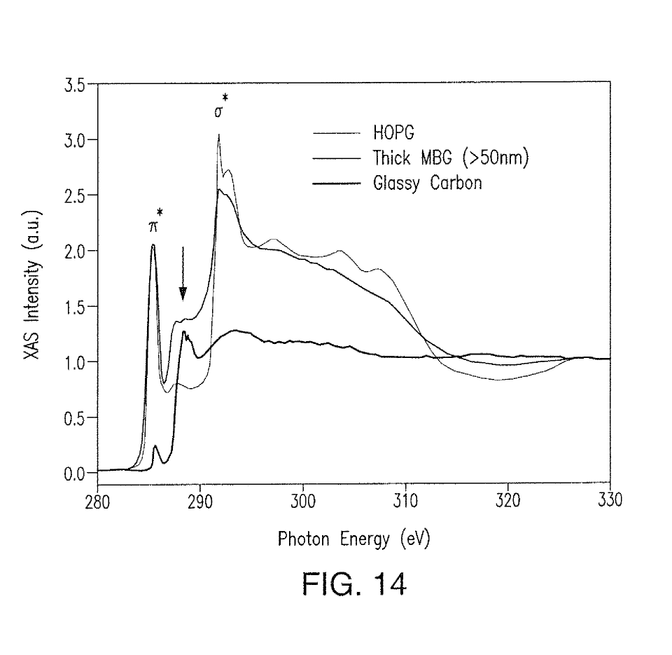

Referring next to FIG. 2, an exemplary method for producing graphene films using the system shown in FIG. 1 will be described. At 2001, a substrate is positioned in the vacuum chamber in a location to receive at least a portion of the carbon upon the application of current to the glassy carbon filament. At 2002, the vacuum chamber is evacuated to create a vacuum pressure within the vacuum chamber. At 2003, electrical current is applied to the glassy carbon filament. At 2004, the substrate receives at least a portion of the carbon emitted from the glassy carbon filament.

In one embodiment, the disclosed subject matter produces graphene films that are transparent or semitransparent and conductive. The method can produce large scale graphene layers that are monolayer or close to monolayer thin. In certain embodiments, the combination of highly controllable growth conditions and dielectric substrates produces films that do not require exfoliation for further examples, and facilitates comprehensive in-depth characterization.

In one embodiment, the carbon source 1002 is heated to a temperature that results in evaporation of the carbon source. In some embodiments, the carbon source 1002 is heated to a temperature of at least 1,900° C. In one embodiment, the carbon source 1002 is heated from about 1,900° C. to about 2,350° C. In some embodiments, the carbon source 1002 is heated from about 1,900° C. to about 2,100° C. In certain embodiments, the carbon source 1002 is heated from about 2,100° C. to about 2,300° C. Non-limiting examples of the temperature that the carbon source 1002 is heated to include about 1,950° C., about 2,000° C., about 2,050° C., about 2,100° C., about 2,150° C., about 2,200° C., about 2,250° C., and about 2,300° C.

In particular embodiments, the carbon source 1002 is heated for a period of time from about one minute to about 500 minutes. In certain embodiments, the carbon source 1002 is heated for about 2 minutes, or about 3 minutes, or about 4 minutes, or about 5 minutes, or about 7.5 minutes, or about 10 minutes, or about 15 minutes, or about 20 minutes, or about 30 minutes, or about 45 minutes, or about 60 minutes, or about 75 minutes, or about 90 minutes, or about 100 minutes, or about 120 minutes, or about 135 minutes, or about 150 minutes, or about 180 minutes, or about 200 minutes, or about 220 minutes, or about 240 minutes, or about 260 minutes, or about 280 minutes, or about 300 minutes, or about 320 minutes, or about 340 minutes, or about 360 minutes, or about 400 minutes, or about 450 minutes.

In certain embodiments, the substrate 1004 is pretreated in order to enhance its ability to receive evaporated carbon. The substrate 1004 can be cleaned prior to being loaded in the evaporation chamber by standard cleaning procedures of surfaces in the microelectronic industry. Non-limiting examples of cleaning procedures are ultrasonic treatments in acetone, methanol and isopropanol

In certain embodiments, the current applied to the electrical contact 1001 is at least 5 A. In certain embodiments, the current applied to the electrical contact 1001 is at least 7.5 A, at least 10 A, at least 20 A, at least 30 A, or less than about 40 A. In an exemplary embodiment, the current is about 5 Å to about 20 A. In certain embodiments, the current applied to the electrical contact 1001 is between about 25 Å and about 250 A. In one embodiment, the current applied to the electrical contact 1001 is between about 25 Å and about 100 A. In certain embodiments, the current applied to the electrical contact 1001 is between about 100 A and about 250 A. In certain embodiments, the voltage applied to the system is at least 3 volts. In certain embodiments, the current applied to the electrical contact 1001 is at least 4 volts, at least 10 volts, at least 20 volts, at least 25 volts, or less than about 50 volts. In an exemplary embodiment, the current is about 3 volts to about 20 volts. In one embodiment, the voltage applied to the system is between about 4 and about 50 volts. These current and volt values are exemplary. The system can be scaled up or down to any size. A larger filament will require higher current and voltage values, and a smaller filament will require lower values.

In certain embodiments, after the graphene layers have been grown on the substrate 1004, the substrate undergoes further treatment. In one embodiment, the substrate is oxygen plasma etched or cleaned with a hydrogen plasma. In certain embodiments, a step edge is fabricated upon the substrate. In some embodiments, photoresist masking is carried out on the substrate. In some embodiments, shadow masking with PDMS or a piece of glass is carried out on the substrate.

The graphene nanocrystalline layers deposited by the presently disclosed subject matter can be used in a wide variety of applications. These include, but are not limited to, semitransparent conducting electrodes for interface interactive touch displays, solar energy harvesting applications, or organic LEDs. Non-limiting examples of applications for the graphene layers prepared by the presently disclosed subject matter include device applications that convert optical signals into electronically usable signals, device applications that convert electronically usable signals into optical signals, conducting electrodes for battery applications, contacts and surface material for hydrogen storage applications, heat conducting layer for heat management of microelectronic devices, energy storage devices (e.g., megacapacitors), or any other application requiring the use of semitransparent conducting electrodes. The graphene nanocrystalline layers or films produced by this method can have a sheet resistance that can be well below to about 100 kOhm/square.

The quality and size of the graphene nanocrystals in the MBG films depend upon the growth conditions. In certain embodiments, the growth rate (“GR”) is controlled. In certain embodiments, the GR is less than about 3.0 A/min, less than about 2.0 A/min, less than about 1.0 A/min, less than about 0.50 A/min, or less than about 0.25 A/min.

U.S. Published Application No. 2006/0236936, U.S. Pat. No. 7,619,257, and International Published Application No. WO 2009/085167 are related to the disclosed subject matter and are hereby incorporated by reference in their entirety.

### EXAMPLES

### Example 1

### Growth of Graphene Layers on Mica

FIG. 1 shows a schematic diagram of the system employed to grow graphene nanocrystalline layers. The glassy carbon was obtained from HTW Hochtemperatur-Werkstoffe GmbH (Thierhaupten, Germany) in the shape of plates. The glassy carbon filament is shown in FIG. 3. The ring-shaped ends of the glassy carbon filament have an outer diameter of 9.6 mm and an inner diameter of 3.2 mm. The electrical contacts are disposed within respective through holes in the ring-shaped ends of the glassy carbon filament and are held securely. The ring-shaped ends of the glassy carbon filament are spaced apart at a center-to-center distance of 17.2 mm. The ring-shaped ends of the glassy carbon filament can be connected by an integrally-formed thin metal strip having a width of 2.5 mm. A pair of concavities can be formed where each ring-shaped end connects with the thin strip and each concavity has an arc of radius 2.4 mm. The glassy carbon was firmly held to the leads, which were made of copper at the ends furthest from the glassy carbon filament and were made of tantalum at the lead end that is in electrical communication with the glassy carbon filament.

A piece of muscovite commercially available mica was placed a distance of 15 mm from the glassy carbon filament and positioned as the substrate S shown in FIG. 4. The system was placed under an Ultra High Vacuum of 10⁻⁹ torr. The glassy carbon filament was heated to about 2,000° C. by the Joule effect of a current of 15 A produced at 6 V.

The graphene layers can be evaluated by Near Edge X-ray Absorption Fine Structure (NEXAFS) and Raman spectroscopy. NEXAFS provides a direct, element-specific probe of bond type and orientation with a high surface sensitivity that enables evaluation of sp²:sp³-bond ratios and the degree of planarity of ultra-thin (single layer) films. Since sp²-hybridized carbon layers have unique spectral fingerprints in both Raman and NEXAFS spectroscopies, the combination of these two methods is suited to probing the crystallinity, bond type and bond configurations (two-dimensional vs. three-dimensional) of the ultra-thin graphene films.

Carbon 1s NEXAFS measurements were performed at the NIST beamline U7A of the National Synchrotron Light Source (NSLS). Measurements were performed in partial electron yield (PEY) mode with a grid bias of −200 V, selected to optimize the surface sensitivity of the measurement and thereby the signal from the graphene film. Angle-dependent NEXAFS was obtained by changing the angle between the incoming x-ray beam (and therefore the E-field vector) and the sample between 20° and 70°, corresponding roughly to out-of-plane and in-plane bond resonances, respectively. The reference absorption intensity (I₀) of the incoming x-ray beam, measured on a gold coated mesh positioned just after the refocusing optics, was measured simultaneously and used to normalize the spectra to avoid any artifacts due to beam instability. A linear background was subtracted from a region before the absorption edge (278-282 eV). Spectra were normalized by area with respect to carbon concentration using a two-point normalization: area normalization between 282 and 300 eV and a continuum normalization in the region 330-335 eV (atomic normalization).

For the Raman examples a Renishaw in Via micro-Raman set-up, equipped with a movable x-y-z stage was employed. The laser power was set to less than 3 mW and was focused with a 100× lens to a spotsize of approximately 0.5 μm.

The growth rate of the graphene layers was about 1 to about 3 Å/min. The NEXAFS spectrum of a graphene layer on mica is shown in FIG. 5. The spectrum demonstrates a high amount of sp² bonds, very few sp³ bonds, a layered structure, and a long range periodic order in electronic structure. The typical sp² features can be observed of 1 s−>n* (285 eV) and 1 s−>σ* (292 eV), while the typical sp³ features of 1 s−>*(289 eV) and second gap (302 eV) are missing.

The Micro-Raman spectrum of graphene layer on mica is shown in FIG. 6. As shown in FIG. 6, the carbon signal disappears for low carbon deposition thickness. The Micro-Raman spectrum has broad peaks and depicts the presence of graphene/graphitic peaks D, G and 2D. There are several peaks around 2,700 cm⁻¹ due to graphene nanocrystals. The ambient scanning tunneling spectroscopy (STM) of the graphene layers on mica is shown in FIG. 7. The STM graph shows that the graphene layers were flat. The graphene films are conductive and show a smooth surface.

As expected for sp² bonded carbon, the MBG films show electrical conductivity at room temperature. Preliminary 4-probe transport measurements reveal a sheet resistivity of a few kΩ; sufficient conductivity for S™ measurements. FIG. 7 shows a three-dimensional ambient STM topography of a MBG film on a mica substrate. The size of the image was 4×4 nm². Several flat terraces were observed. A line profile, along the bracketed line in FIG. 13(a), reveals 0.33 nm high steps, as shown in FIG. 7. These step-heights were comparable to the interlayer distance in graphite, as would be expected in graphene multilayers. The surface roughness was dominated by the roughness of the underlying substrate. This has been confirmed by tapping-mode atomic force microscopy (AFM) measurements.

After the graphene layers were formed, edges in the graphene layer were fabricated with photoresist masking and oxygen plasma etching. AFM was used to measure the step heights as depicted in FIG. 8. Standard cleanroom procedures were applied for fabrication.

This example demonstrated the successful growth of ultrathin graphitic films on mica.

The presence of primarily sp² bonds in the graphene layers was confirmed by NEXAFS. The Micro-Raman spectrum was consistent with a graphitic-like material. The physical properties of the graphene films correspond to conductive semitransparent electrodes with a sheet resistance of about 30 kOhm/square.

### Example 2

### Growth of Graphene Layers on Silicon Dioxide

The method to prepare the graphene layers is the same as that described in Example 1. A piece of a 300 nm thick thermally grown silicon dioxide on Si(100) was placed in the sample holder a distance of 15 mm from the glassy carbon filament. The system was placed under an Ultra High Vacuum of 10⁻⁹ torr. The glassy carbon filament was heated to about 2,000° C. by the Joule effect of a current of 15 A produced at 6 V. The evaporation occurred over a period of time of from about 3 to about 300 minutes.

The results for the graphene layers grown on silicon dioxide are similar to those for the layers grown on mica in Example 1. The growth rate of the graphene layers was about 0.1 to about 3 Å/min. The Micro-Raman spectrum of a graphene layer on silicon dioxide is shown in FIG. 9. The carbon signal disappears for low carbon deposition thickness. The spectrum exhibits peaks and intensities in the expected region. The D-peak was at around 1350 cm⁻¹, the G-peak was at around 1600 cm⁻¹, and the 2D-peak was at about 2700 cm⁻¹. These peaks vary based on the layer conditions, including domain size, strain, and doping.

This example demonstrated the successful growth of ultrathin graphitic films on silicon dioxide. The Micro-Raman spectrum was consistent with a graphitic-like material.

### Example 3

### Growth of Graphene Layers on Various Substrates

Ultra-thin graphene film growth of graphene nanocrystals on dielectric substrates were achieved in the set-up illustrated in FIG. 10. The substrates were 6×25 mm² amorphous SiO₂ (300 nm), crystalline mica, and crystalline silicon. The substrates were cleaned by sonication in acetone and isopropanol prior to loading in the growth chamber. Mica samples were cleaved ex-situ and loaded immediately into the UHV system.

The UHV chamber, which had a base pressure of approximately 6×10⁻¹⁰ mbar, incorporated a solid carbon source that was made of glassy carbon. The dimensions of the carbon source were 10×2.5×0.3 mm³. The carbon source was heated by a DC current of approximately 15 A to an operating temperature of approximately 2100° C., which was monitored by a Marathon MM Raytech optical pyrometer. The solid carbon source was located in close proximity to the substrate, as shown in FIGS. 10(a) and (c). The substrates were heated to approximately 400° C. to remove adsorbed water before the growth. The pressure reached during growth was approximately 5×10⁻⁸ mbar. Due to the proximity of the solid carbon source, the temperature of the substrates during growth reached approximately 500° C., with a gradient of less than 100° C. over their 25 mm length.

In the growth set-up shown in FIG. 10(a), D0 was the distance between the carbon source and the sample (approximately 15 mm) and d was the position on the substrate. Θ0 was the thickness at d=0. In this configuration, the flux of carbon atoms was relatively high at the near end of the substrate (d=0) and decreased significantly along the length of the substrate.

Raman spectroscopy and NEXAFS measurements were obtained as described in Example 1 above. Ambient STM and atomic force microscopy (AFM), in tapping mode, were performed to get additional insight into the surface morphology of the grown films.

The homogeneity of the material throughout the volume was probed with NEXAFS by varying a bias voltage applied to the sample. By changing the voltage from −250 to −50 V, the depth within the carbon film from which detected electrons were emitted was tuned from about 1 nm to about 7 nm, providing a maximum film thickness θ₀<3.5 nm. The higher voltage allowed detection of electrons only from the near surface-region.

The geometrical dependence of the flux is best described as a growth rate gradient along the length of the substrate. The calibration of the growth rate was achieved by measuring the profile of a thick MBG film (>30 nm) on a SiO₂ substrate using an atomic force microscope or optical profilometer. The position-dependent GR(d), derived from the position-dependent thickness Θ(d), was calculated according to the following formula:

$$G R ( d ) = \frac{Θ ( d )}{t} = \frac{{Θ}_{0} / {( 1 + {( \frac{d}{{D}_{0}} )}^{2} )}^{2}}{t} . \qquad ( 2 )$$

where t is the deposition time. The maximum GR, typically 1-2 Å/min, was reached for d=0. As d increased, GR(d) decreased to a minimum value of 0.1 Å/min or less.

FIG. 11 shows typical Raman and NEXAFS measurements for a MBG film grown on a 300 nm-thick SiO₂ layer on Si. Two main regions with very distinct characteristics can be identified. The dashed line in FIG. 11 marks the border between these two regions, corresponding to high OR (upper half) and low GR (lower half), respectively.

Characteristic Raman signatures of optical phonons for graphite were observed along the GR gradient, as displayed in the color plot of FIG. 11(b). The band at approximately 1600 cm-1 resulted from superposition of the G and the D′ modes. The G mode was a long wavelength optical phonon originating from in-plane bond-stretching motion of pairs of sp² hybridized carbon atoms. The D′ mode was induced by disorder and requires intra-valley electron-phonon scattering. The D mode at approximately 1344 cm⁻¹, which requires the presence of six-fold aromatic rings, was induced by disorder, such as edges or atomic defects. The bands resolved at higher Raman shifts are also well known: the two-dimensional mode at approximately 2700 cm⁻¹ (a.k.a. G′), the G+D band slightly below approximately 3000 cm⁻¹ and a third one at approximately 3200 cm⁻¹ matching the energy of the G+D′ mode. The third band was observed visually but it was not discernible in the color plot of FIG. 11(b).

The intensity of all Raman features decreases with decreasing GR (film thickness), while the relative intensities of D and G bands vary with the GR. For higher GR (upper part of FIG. 11), the D mode was more intense than the G mode, as shown in the left panel of FIG. 11(b). In addition, at higher GR a significant Raman intensity was observed between the G and D modes, which originates from the presence of disordered carbon bonds. At lower OR (below the dashed line of FIG. 11), the peak intensity ratio I(D)/I (G) diminishes and the G and D bands become better resolved due to the Raman intensity between those two modes decreasing drastically. Both observations point to a larger crystal size and a higher crystal quality for lower growth rates.

The two Raman spectra (GR=1.08°A/min), shown at the bottom of FIG. 11(b), demonstrate that by changing the excitation laser wavelength from approximately 532 nm (green trace) to approximately 633 nm (red trace), there was a clear redshift in the positions of the D and two-dimensional Raman bands. In crystalline graphene layers, such a redshift arises from the wave-vector dispersion of the optical phonons. The size of the frequency shift that was observed was comparable to those that are typical for graphite and graphene. The observed energy dispersion of the graphene films provides further evidence of crystallinity.

The two growth regions have the distinct NEXAFS signatures, as shown in FIG. 11(c). In both regions were spectral fingerprints of sp²-hybridized carbon, specifically strong peaks at 285.4 and 292.0 eV that correspond to excitation of a carbon 1s core electron to the unoccupied π* and σ* orbitals, respectively. The sharpness of the NEXAFS features indicates a well-defined bonding environment and long-range periodic order in the electronic structure. The σ* fine structure was specifically characteristic of graphite, and includes a sharp onset due to an excitonic core hole-valence state interaction and the broader σ* peak at approximately 1 eV higher photon energy due to more delocalized σ* states. Thus, the NEXAFS spectra demonstrated the formation of sp² bonds between carbon atoms in the graphene films.

NEXAFS is also sensitive to substrate-relative bond-orientations. Being governed by the transition dipole matrix element between a core electron and an unoccupied orbital above the Fermi level, the NEXAFS intensity depends upon the angle between the electric field vector of the incoming x-ray beam and the molecular orbitals in the system (see inset of FIG. 12). Hence, the degree of bond anisotropy in the sp² films was directly probed by changing the angle of the incident x-ray beam from near parallel (20°) to near perpendicular (70°) to the substrate, while the E-field vector was perpendicular to the beam axis.

For higher GR, as demonstrated in the upper half of FIG. 11(e), no angular dependence of the NEXAFS resonances was observed, indicating a fairly isotropic arrangement of sp² bonds. In contrast, the NEXAFS intensity becomes strongly dependent on incident angle at lower GR, as demonstrated in the lower half of FIG. 11(c). The intensity of the π* (σ*) peak was at its maximum (minimum) at 20° and minimum (maximum) at 70° incidence. Similarly, the intensity of the σ* peak was at its minimum at 20° and maximum at 70° incidence. These results indicate highly oriented planar C═C bonds parallel to the substrate surface. Here, the sp² carbon layers grow in a two-dimensional plane. The ability to grow sp² carbon layers well aligned to the plane of the substrate, and the presence of two regions with distinctly different degrees of bond anisotropy was emphasized by the inset of FIG. 11(c), which plotted the area of the π* peak as a function of the incident angle for the two regions.

Since a bias-dependency of the spectral features was not observed, the films were homogenous throughout the volume. This excludes the possibility of initial formation of a planar film in the isotropic region of the films followed by accumulation of defects as the film thickness was increased.

Detailed analysis of Raman lineshapes enables estimates of the crystallite sizes. Typical Raman spectra of MBG nanocrystals grown on SiO₂ were shown in FIG. 13. A linear background subtraction between 1900 cm-1 and 2300 cm⁻¹, was applied.

FIG. 13(a)-(d) showed results at high growth rates. The blue shift of the G band to approximately 1600 cm⁻¹ (from approximately 1585 cm⁻¹ in graphite) seen in FIGS. 13(a) and (c) was attributed to the unresolved superposition of the G and D′ Raman modes. The Raman intensity between the D and G band was tentatively interpreted as from disorder at the grain boundaries. In addition to the two-dimensional (G′) band at (approximately 2672 cm⁻¹), two second-order bands at higher Raman shifts (FIGS. 13(b) and (d)) were observed: G+D at approximately 2928 cm⁻¹ and G+D′ at approximately 3202 cm⁻¹. These allowed a calculation of the energy shifts of the G and D′ modes, which thereby were found to be at 1584 cm⁻¹ and 1618 cm⁻¹, respectively. All these values were in good agreement with previous reports for such graphene-like systems.

FIG. 13(e) showed results at lower growth rates: Here the G mode redshifts to approximately 1585 cm⁻¹, indicating that the contribution of the D′ band was reduced, most likely as a consequence of a larger nanocrystal size. In addition, the D-mode intensity was reduced relative to the G mode and the intensity between those two modes decreased. Four Lorentzians, corresponding to the three graphene optical phonon frequencies: D, G and D′; and a fourth one related to the 3TO Si phonon (at 1450 cm⁻¹), reproduced the data.

The intensity ratio I(D)/I(G), provides an estimate of the crystallite dimensions. The graph of FIG. 13(f) reveals an unambiguous trend: that the grain size increases up to 22 nm on reducing the GR. This result was consistent with the reduced Raman intensity between the D and G lines in FIG. 13(e).

Based upon NEXAFS and Raman spectroscopy, non-epitaxial growth of graphene on insulating substrates by using a molecular beam of carbon atoms was achieved to obtain quality, ultra-thin graphene films.

The NEXAFS and Raman spectra demonstrated that lowering the growth rate is an important parameter for two-dimensional (layered) growth of graphene crystals, as it strongly influences the alignment of the sp²-bonds. NEXAFS spectra for high growth rates reveal isotropic orientation of the sp²-bonds. This growth can be regarded as quasi-three-dimensional. Reducing the growth rate increased the crystallite size to approximately 22 nm and aligned the graphene multilayer-crystals parallel to the substrate. The reduction of grain boundaries manifested as reduced Raman scattering intensity between the D and G bands and anisotropy in the bond-orientations in angle-dependent NEXAFS measurements.

Typical graphene film parameters, such as but not limited to growth rate, substrate temperature, surface mobility, and the graphene film growing setup itself, offer a wide parameter space in which to explore the growth of a range of layered materials with van der Waals coupling between the layers. At the same time, the present method of preparing graphene films allows for the growth of heterostructures based on these layered materials. In one embodiment, the use of smoother and more inert substrates, like hexagonal boron nitride, could be employed to obtain high crystal quality.

### Example 4

### Angle-Dependent NEXAFS for Various Substrates

A few-layer (approximately 2 nm) graphene layer was prepared by the process described in Example 3 (MBG films) on both SiO₂ and on mica. The substrates are 6×25 mm². A single high-quality graphene layer grown on copper foil by chemical vapor deposition (“CVD”). The CVD layers were prepared as described in Nature Nanotech 5(8): 574-8 (2010), Nature 457(7230): 706-10 (2009), and Science 324 (5932): 1312-4 (2009). Angle-dependent NEXAFS measurements in the low-growth-rate region were obtained for the graphene layers on the samples.

As demonstrated in FIG. 12, the NEXAFS spectra from the samples prepared according to Example 3 and the CVD grown graphene are very similar, including the energy position and angular dependence of the NEXAFS features. Incident angles of 20° and 70° corresponded roughly to out-of-plane and in-plane polarizations, as shown schematically in the inset in FIG. 12. Aside from a slightly weaker angular dependence of the MBG films, the main difference between the MBG and CVD spectra was the intensity in-between the π* and σ* resonances, which was due to C—O and C—H bonds (a resonance due to an interlayer state in few-layer graphene also appears in this region).

The intensity between the π* and the σ* resonances can be explained by the larger number of dangling bonds available at the grain boundary of the MBG nanocrystals, due to their smaller grain size compared to those in the CVD samples. These were readily saturated by oxygen and hydrogen bonds. These bonds tend to distort the planarity of graphene films. Without being bound by theory, it is also believed that this explains the suppressed angular dependence of the NEXAFS data for the MBG films compared to CVD graphene.

No features associated with sp³ carbon-carbon bonds were observed in the NEXAFS data. Therefore, the data demonstrated planar layered sp² graphitic bonds in films grown under the conditions of this example.

### Example 5

### NEXAFS for Thick Graphene Films

Orientation-independent NEXAFS of bulk material measured near 50° was obtained. The NEXAFS data was obtained from three samples: a thick graphene film (Θ0=54.4 nm), a film prepared from glassy carbon used as carbon source, and a film prepared from highly-ordered pyrolytic graphite (“HOPG”).

The NEXAFS data is shown in FIG. 14. While the NEXAFS spectrum of the ultra-thin graphene film was very similar to that of HOPG, distinct differences were observed from the glassy-carbon spectrum, which had significant sp³ content. The sp²−π* and σ* peaks were strongly suppressed and the sp²−σ* peak was significantly broadened. An onset and a peak centered around 289 eV appeared due to the sp³−σ* absorption edge of diamond and a C—H resonance.

In contrast, the thick graphene film and the HOPG traces possessed the spectral signatures of sp² bonds. HOPG had better long range periodic ordering, as was evidenced by the sharpness of the σ* resonance. As in FIG. 12, the graphene films demonstrated some C—H and C—O bonds at the grain boundaries of the nanocrystals, as well as non-uniform bonding between the differently oriented graphene nanocrystals in three dimensions, giving rise to the intensity between the sp²−σ* and π* resonances, as indicated by the arrow in FIG. 14.

A person having ordinary skill in the art will recognize that the particular examples disclosed herein are for illustration purposes only and do not limit the scope of the disclosed subject matter. For example, a person having ordinary skill in the art will recognize that the disclosed systems and methods for thermal evaporation can be implemented on smaller and larger scales than those disclosed. In some embodiments, the material container can be enlarged to achieve larger area growths and larger growth rates. In some embodiments, the size of the components can be reduced to implement a miniature carbon evaporator.

Many variations of the present invention will suggest themselves to those skilled in the art in light of the above detailed description. All such obvious variations are within the fully intended scope of the appended claims.

What is claimed is:

1. A system for deposition of a graphene nanocrystalline layer on a substrate using one or more glassy carbon filaments, comprising:
a vacuum chamber adapted to provide a pressure of less than about 10⁻³ torr;
one or more sets of electrical contacts, each coupled to the vacuum chamber and configured to receive at least one of the one or more glassy carbon filaments, to provide a source of carbon for graphene growth upon application of a current thereto;
a heating element, coupled to the vacuum chamber and adapted to heat the one or more glassy carbon filaments to a temperature that results in evaporation of the glassy carbon filament when the pressure is of less than about 10⁻³ torr; and
at least one substrate holder, adapted to receive the substrate, and disposed in the vacuum chamber in a location to receive at least a portion of the graphene carbon upon the application of the current to the one or more glassy carbon filaments when heated to a temperature that results in evaporation of the glassy carbon filament when the pressure is of less than about 10⁻³ torr.

2. The system for deposition of a graphene nanocrystalline layer of claim 1, wherein the heating element is adapted to heat the one or more glassy carbon filaments to a temperature of at least 1,900° C.

3. The system for deposition of a graphene nanocrystalline layer of claim 1, wherein the vacuum chamber is adapted to provide a pressure of less than about 10⁻⁶ torr.

4. The system for deposition of a graphene nanocrystalline layer of claim 1, wherein the graphene nanocrystalline layer can be sub-monolayer thin.

5. The system for deposition of a graphene nanocrystalline layer of claim 1, wherein the graphene nanocrystalline layer can be a large scale graphene layer.

6. The system for deposition of a graphene nanocrystalline layer of claim 1, further comprising a shutter coupled to the vacuum chamber to mechanically control the amount of carbon delivered to the substrate.

7. A method for applying a graphene nanocrystalline layer on a substrate in a vacuum chamber including at least one glassy carbon filament, comprising:
a) positioning the substrate in the vacuum chamber;
b) evacuating the vacuum chamber to a pressure of less than 10⁻³ torr; and
c) applying an electrical current to the glassy carbon filament to thereby generate a beam of carbon, wherein the positioning comprises disposing the substrate in a location to receive at least a portion of the carbon upon the application of current.

8. The method of claim 7, wherein the method further comprises mechanically controlling the amount of carbon delivered to the substrate.

9. The method of claim 7, further comprising heating the glassy carbon filament to a temperature of at least 1,900° C.

10. The method of claim 7, wherein the method further comprises providing a pressure of less than about 10⁻⁶ torr.

11. The method of claim 7, wherein the method further comprises providing a pressure of less than about 10⁻⁹ torr.

12. The method of claim 7, wherein the method further comprises providing a substrate in proximity to the glassy carbon filament.

13. The method of claim 12, further comprising selecting a dielectric substrate as the substrate.

14. The method of claim 13, wherein the dielectric substrate is selected from the group consisting of glass, sapphire, mica, silicon dioxide, silicon nitride, silicon oxy-nitride, aluminum oxide, silicon carbide nitride, organo-silicate glass, carbon-doped silicon oxides, or methylsilsesquioxane (MSQ).

15. The method of claim 12, further comprising selecting a semiconducting substrate as the substrate.

16. The method of claim 15, wherein semiconducting substrate is selected from the group consisting of silicon, silicon carbide, zinc selenide, gallium arsenide, gallium nitride, cadmium telluride or mercury cadmium telluride.

17. The method of claim 7, wherein the current applied is at least 7.5 A.
